(19) United States
(12) Patent Application Publication
(10) Pub. No.: US 2003/0154783 A1
(43) Pub. Date: Aug. 21, 2003

(54) Procedure for operating a device for measuring fill-level and device for measuring fill-level

(76) Inventor: Ralf Koernle, Zell am Harmersbach (DE)

Correspondence Address: NATH & ASSOCIATES PLLC, Sixth Floor, 1030 15th Street, N.W., Washington, DC, 20005, US

(21) Appl. No.: 10/247,732

(22) Filed: Sep. 20, 2002

(30) Foreign Application Priority Data
Feb. 16, 2002 (DE) 102 06 463.6

(51) Int. Cl. G01F 23/00

(52) U.S. Cl. 73/291; 73/290 R

(57) ABSTRACT

In order to configure device for measuring fill-level (1) as customer and operation friendly, interface (2), which can be mechanically connected and disconnected to/from device for measuring fill-level (1), for attaching an electronic device, for example, a personal computer or an indication or operation module, is provisioned. It is advantageous for the interface to be integrated into indication and operation module (2). The transfer of data, as well as of a power current, between device for measuring fill-level (1) and interface (2) occurs, for example, by means of an inductive, capacitive, or optical coupling. Interface (2) can be mechanically connected and disconnected to/from device for measuring fill-level (1), for example, by means of a plug-in or lock-in connection, or by means of at least one magnet.

The invention concerns a procedure for operating a device for measuring fill-level, where a measuring sensor measures the fill-level and converts it into an electrical or optical measurement signal.

The invention further concerns a device for measuring fill-level with a measuring sensor for measuring the fill-level and for generating an electrical or optical signal to represent the fill-level.

Several measurement principles for measuring the fill-level of solid bulk goods or of liquids in a container or tank are known. For example, the fill-level measurement is indicated with radar, by means of swinging rods, by means of pressure, and by means of capacity measurements.

When measuring the fill-level, a measuring sensor measures the fill-level and generates the electrical or optical measurement signals that represent the fill-level, which are, for example, transmitted to an indicator apparatus or an evaluation apparatus. Before implementation for operation of a device for measuring fill-level, customer-specific parameter data must be entered into the device for measuring fill-level. Upon replacement of the measuring sensor, parameter data must be newly entered into the device for measuring fill-level. These parameter data are entered into the device for measuring fill-level by means of an indication and operation module.

It is the problem of the invention at hand to produce a procedure for operation of a device for measuring fill-level and to configure a device for measuring fill-level as customer and service friendly as possible.

According to the procedure, this problem is solved through the characteristics indicated in claim 1, which states that an interface is mechanically connected with the device for measuring fill-level, in order for an electronic device to be attached.

According to the device, this problem is solved through the characteristics indicated in claim 6, which states that an interface for attaching an electronic device can be mechanically connected and disconnected to/from the device for measuring fill-level.

The procedure, according to the invention, provisions that an interface for attaching an electronic device, a personal computer for example, or an indication and operation module, is connected mechanically to the device for measuring fill-level. The interface can, for example, be integrated into the indication and operation module.

The interface can, for example, be mechanically connected and disconnected to/from the device for measuring fill-level by means of a plug-in or lock-in apparatus, or by means of at least one magnet.

It is advantageous for the interface and the device for measuring fill-level to be galvanically separated from one another. The transmission of measurement signals and data, parameter data for example, as well as power current, can occur in an inductive, capacitive, or optical manner.

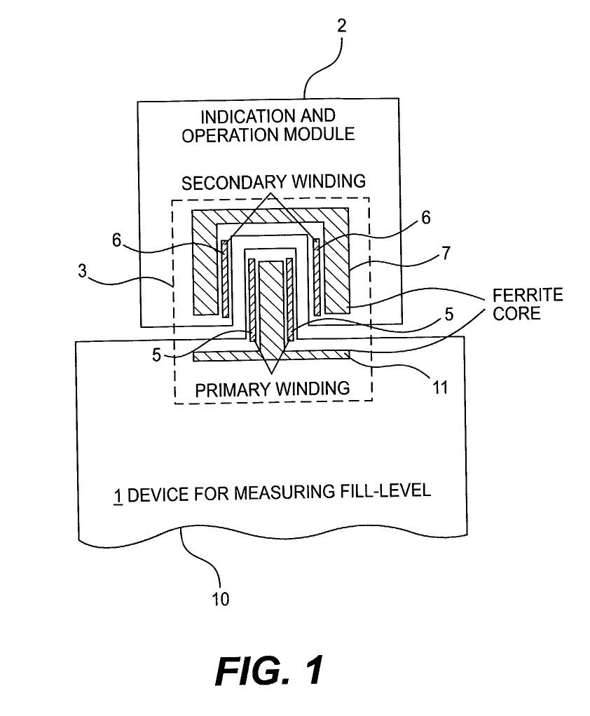

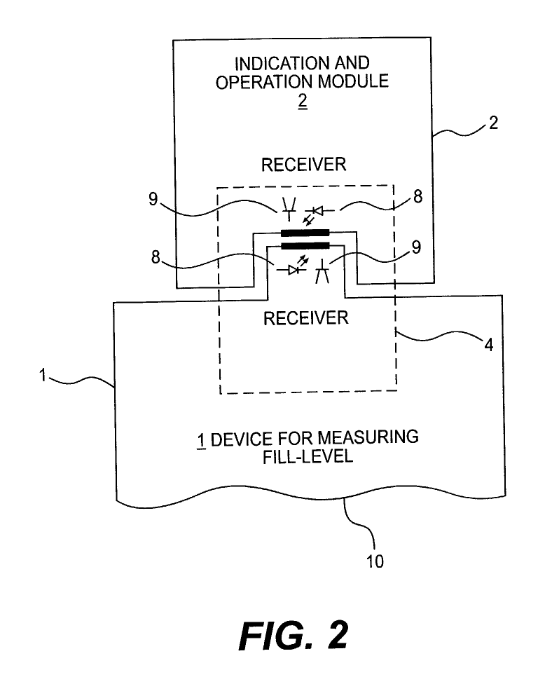

The invention is now described in greater detail with the help of the drawings. Shown are: FIG. 1 a first embodiment and FIG. 2 a second embodiment of the invention.

FIG. 1 shows a first embodiment of the invention.

Device for measuring fill-level 1, for measuring the fill-level of a liquid or of bulk goods 10 is equipped with ferrite core 7, and with primary winding 5. Indication and operation module 2, which is also equipped with ferrite core 12, as well as with secondary winding 6, can be set onto the device for measuring fill-level by means of a plug-in or lock-in apparatus, or by means of at least one magnet, so that primary winding 5 and ferrite core 7 of device for measuring fill-level 1 are inserted into secondary winding 6 and ferrite core 12 of indication and operation module 2.

The transmission of the measurement signals generated by the measuring sensor to indication and operation module 2 occurs inductively, by means of inductive coupler 3, which is formed by primary winding 7 and secondary winding 6 and ferrite cores 7 and 12. This is also the manner in which the data transmission occurs from indication and operation module 2 to device for measuring fill-level 5 [sic; 1].

A second embodiment of the invention is represented in FIG. 2, which is different from the first one in FIG. 1 in that, instead of an inductive coupler, an optical coupler is provisioned.

Device for measuring fill-level 1 is equipped with optical transmitter 8 and optical receiver 9. Indication and operation module 2, which can be set onto device for measuring fill-level 1 by means of a plug-in or lock-in apparatus, or by means of at least one magnet, is also equipped with optical transmitter 8 and optical receiver 9. Indicator and operation module 2 is set onto device for measuring fill-level 1 in such a way that each optical transmitter 8 is opposite an optical receiver 9.

The measurement signals generated by the device for measuring fill-level, as well as the data transferred from the indication and operation module to device for measuring fill-level 1, are transmitted by means of the optical coupler, formed by optical transmitters 8 and optical receivers 9.

The power current can be supplied either inductively or optically in both embodiments. It is advantageous to select the same method of transmission for the transfer of the power current as used for the transfer of data.

In place of an indication and operation module, an interface to an electronic device, a personal computer for example, can also be mechanically connected and disconnected to/from the device for measuring fill-level.

List of Terms

List of terms

| | |
|---|---|
| 1 | Device for measuring fill-level |
| 2 | Indication and operation module |
| 3 | Inductive coupler |
| 4 | Optical coupler |
| 5 | Primary winding |
| 6 | Secondary winding |
| 7 | Ferrite core |
| 8 | Optical transmitter |
| 9 | Optical receiver |
| 10 | Liquid, bulk goods |

1. Procedure for operating device for measuring fill-level (1), where a measuring sensor measures the fill-level and converts it into an electrical or optical signal, wherein interface (2) is mechanically connected with device for measuring fill-level (1) in order for an electronic device to be attached.

2. Procedure according to claim 1, wherein indicator and operation module (2) is mechanically connected with device for measuring fill-level (1) in order for device for measuring fill-level (1) to be parameterized.

3. Procedure according to claim 1 or 2, wherein interface (2) is connected to device for measuring fill-level (1) by means of a plug-in or lock-in connection, or by means of at least one magnet.

4. Procedure according to claim 1, 2, or 3, wherein interface (2) is galvanically separated from device for measuring fill-level (1).

5. Procedure according to claim 4, wherein the transmission of data and/or of the power current, between interface (2) and device for measuring fill-level (1), occurs in an inductive manner by means of inductive coupler (3), in a capacitive manner by means of a capacitive coupler, or in an optical manner by means of optical coupler (4).

6. Device for measuring fill-level (1) with a measuring sensor for measuring the fill-level and for generating an electrical or optical measurement signal to represent the fill-level, wherein interface (2) can be mechanically connected and disconnected to/from device for measuring fill-level (1) in order for an electronic device to be attached.

7. Device for measuring fill-level according to claim 6, wherein indicator and operation module (2) can be mechanically connected and disconnected to/from device for measuring fill-level (1) in order for device for measuring fill-level (1) to be parameterized.

8. Device for measuring fill-level according to claim 6 or 7, wherein interface (2) can be connected and disconnected from/to device for measuring fill-level (1) by means of a plug-in or lock-in connection, or by means of at least one magnet.

9. Device for measuring fill-level according to claim 6, 7, or 8, wherein interface (2) is galvanically separated from device for measuring fill-level (1).

10. Device for measuring fill-level according to claim 9, wherein the transmission of data and/or of the power current, between interface (2) and device for measuring fill-level (1), occurs in an inductive manner by means of inductive coupler (3), in a capacitive manner by means of a capacitive coupler, and/or in an optical manner by means of optical coupler (4).
